(19) United States
(12) Patent Application Publication
(10) Pub. No.: US 2019/0165399 A1
(43) Pub. Date: May 30, 2019

(54) FUEL CELL FILTER ELEMENT AND FUEL CELL FILTER SYSTEM HAVING ONE SUCH FUEL CELL FILTER ELEMENT

(71) Applicant: MANN+HUMMEL GmbH, Ludwigsburg (DE)

(72) Inventors: Ina Woitoll, Ilsfeld (DE); Michael Fasold, Auenwald (DE); Karlheinz Muenkel, Oberderdingen-Flehingen (DE); Mathias Volker, Otterstadt (DE)

(21) Appl. No.: 16/194,856

(22) Filed: Nov. 19, 2018

Related U.S. Application Data
(63) Continuation of application No. PCT/EP2017/059838, filed on Apr. 25, 2017.

(30) Foreign Application Priority Data
May 19, 2016 (DE) 102016006073.5

(51) Int. Cl. H01M 8/0662; B01D 53/04; B01D 46/00; B01D 46/52

(52) U.S. Cl. CPC H01M 8/0687; B01D 53/0407; B01D 2253/25; B01D 46/521; B01D 2253/102; B01D 46/0036

(57) ABSTRACT

A fuel cell filter element is provided with a carrier medium and an adsorption agent, wherein the carrier medium and the adsorption agent are joined to a single-layer or multi-layer body. A plastic frame is provided wherein the single-layer or multi-layer body is directly fixedly connected to the plastic frame by injection molding or blow molding. The plastic frame has a connecting surface for connecting to a housing wall of a filter system into which the fuel cell filter element is insertable. A fuel cell filter system with such a fuel cell filter element is provided.

### CROSS-REFERENCE TO RELATED APPLICATIONS

This application is a continuation application of international application No. PCT/EP2017/059838 having an international filing date of 25 Apr. 2017 and designating the U.S., the international application claiming a priority date of 19 May 2016, based on prior filed German patent application No. 10 2016 006 073.5, the entire contents of the aforesaid international application and the aforesaid German patent application being incorporated herein by reference.

### BACKGROUND OF THE INVENTION

The invention concerns a fuel cell filter element, in particular for the air to be supplied to a fuel cell, and a fuel cell filter system with a fuel cell filter element according to the preambles of the independent claims.

U.S. Pat. No. 7,758,674 B2 discloses a filter element for the air to be supplied to a fuel cell. By means of the filter element, dirt particles as well as chemical contaminants can be removed from the air. For this purpose, the filter element comprises a filter nonwoven at which the dirt particles are separated as well as a layer of activated carbon that serves as an adsorption agent for adsorption of gaseous components in the air.

An object of the invention is to configure with simple measures a filter element, comprising activated carbon as an adsorption agent, in such a way that the filter element is exchangeable with little expenditure.

A further object of the invention is to configure a filter system in such a way that the filter element is exchangeable with little expenditure.

### SUMMARY OF THE INVENTION

The aforementioned objects are solved according to one aspect of the invention by a fuel cell filter element, in particular a fuel cell filter element for the air to be supplied to a fuel cell, that comprises a carrier medium and an adsorption agent. In this context, the carrier medium and the adsorption agent are joined to a single-layer or multi-layer body which is embedded in a plastic frame. According to another aspect of the invention, the aforementioned objects are solved by a filter system with such a filter element.

Expedient embodiments and advantages of the invention result from the further claims, the description, and the drawing.

A fuel cell filter element is proposed, in particular a fuel cell filter element for the air to be supplied to a fuel cell,that comprises a carrier medium and an adsorption agent, wherein the carrier medium and the adsorption agent are joined to a single-layer or multi-layer body which is embedded in a plastic frame.

The filter element according to the invention can advantageously be used to chemically filter out contaminants in a gas stream by adsorption. The filter element is used, for example, for purifying the air to be supplied to a fuel cell in that gaseous contaminants in the air are adsorbed.

The filter element comprises, on the one hand, a carrier medium and, on the other hand, activated carbon as adsorption agent, for example, which is immobilized according to the invention by the addition of adhesive. This makes it possible to realize densely packed activated carbon layers which maintain their structure, in contrast to lose activated carbon bulk material, even under mechanical load as well as over an extended operating period; displacements and local compaction of the activated carbon particles that may lead to impairment of the adsorption performance are avoided. Impairments of the adsorption performance are caused, for example, by local voids in the bulk material which may cause leakages. Due to the immobilization of the activated carbon particles, the air permeability is higher in the embodiment according to the invention in comparison to lose bulk material with activated carbon particles of comparable grain diameter. The immobilization of the activated carbon particles has furthermore the advantage that different geometries of the filter element or of the layers of the carrier medium and of the activated carbon can be produced. Conceivable are rectangular as well as non-rectangular shapes. The immobilization of the activated carbon particles in the activated carbon layer is achieved by addition of adhesive whose adhesive threads adhere to the surface of the activated carbon particles and connect various activated carbon particles to each other without however impairing the adsorption performance of the activated carbon. As adhesive, for example, a reactive adhesive is conceivable, for example, based on polyurethane or silane. Possible is also a thermoplastic adhesive that is produced, for example, based on polyolefins.

This embodiment enables the configuration of open carrier layer-activated carbon layer stacks with immobilized activated carbon layer. Such stacks which are referred to as media layer and comprise a carrier layer as well as an activated carbon layer can be stacked on each other wherein the flow direction is in the stacking direction, i.e., orthogonal to the plane of the layers. In a preferred embodiment, two media layers, each comprised of a carrier layer and an activated carbon layer, are stacked on each other in such a way that the activated carbon layers of the two media layers adjoin each other immediately; these two media layers form together a stack unit. In the stacked state, two different activated carbon layers are thus contacting each other immediately inside a top and a bottom carrier layer. Such stack units can be optionally further stacked on each other in order to achieve a desired total thickness of the filter element with a corresponding filtration performance.

Moreover, it is possible in a simple way to combine different activated carbon types per layer, for example, different raw materials such as coconut, coal, charcoal or synthetic starting materials, different activation levels, different catalytic properties, and different impregnations. In this way, an adaptation to the target gas spectrum is possible.

According to a further expedient embodiment, the activated carbon layer is sealed at its long and/or wide side so that, together with the carrier layers resting against the side faces, a boundary of the activated carbon layer can be realized on all sides, as needed. Sealing at the long and/or wide sides increases the stability and improves the reliability in regard to delamination and displacements in the activated carbon layer. Sealing can be realized by a plastic material or adhesive or, alternatively, also by a lateral band which is glued to the sides.

It is provided according to the invention that the single-layer or multi-layer body is fixedly directly connected with the plastic frame without additive, for example, by an injection molding or blow molding method. This has the advantage that filter and housing can be produced in one working step; embedding is realized directly in the process step and gluing the filter element into the housing is eliminated and, moreover, a lateral band for sealing is obsolete. Moreover, it can also be ensured in this way that no leakage flow occurs between housing and filter element.

The plastic frame comprises a connecting surface for connecting with a housing wall of a filter system into which the filter element can be inserted. In this way, a defined interface to the housing wall is provided which greatly facilitates an assembly process. Via the connecting surface, the filter element can be welded into a housing, for example.

Beneficially, the plastic frame can comprise a connecting flange which makes it possible to configure the filter element as a modular part of the entire filter system and in particular of the housing. In this way, the exchangeability of the filter element is moreover greatly facilitated during service.

In an advantageous embodiment, the plastic frame can comprise a welding and/or gluing surface at the outer circumference and/or at one or two end faces. Welding the filter element enables, on the other hand, a permanent and reliable connection to the housing of a filter system. Moreover, in this way, a very reliable sealing action is possible also.

Advantageously, the body can be provided, at a specified inflow side, with a particle filter which can be embodied in particular as a particle filter with a folded filter medium and can be stabilized by one or several webs or a support grid. The particle filter serves for filtering out coarser particles while the activated carbon serves for chemically binding contaminants contained in the fluid to be filtered. Folded filter media comprise large surface areas in comparison to their volume, for which reason they can be used very effectively in filters. Webs or support grids serve for mechanical stabilization of the entire particle filter.

Expediently, the one or several lateral edges of the body, prior to embedding by injection molding, can be sealed by a sealing element, whereby the manufacturing process is simplified because the tool into which the body is inserted is protected from possible contamination by filter material. The sealing element can be embodied in the form of a lateral band that is glued on, for example.

In this way, the activated carbon layer is sealed at its long and/or wide sides so that, together with the carrier layers resting against the side faces, a boundary of the activated carbon layer on all sides can be realized, as needed. The sealing action at the long and/or wide sides increases the stability and improves the reliability against delamination and displacements in the activated carbon layer.

In a beneficial configuration, the particles of the adsorption agent can be immobilized by addition of adhesive, in particular a reactive adhesive or a thermoplastic adhesive, in order to be able to easily realize different shapes of the body configuration.

According to a further expedient embodiment, the carrier medium is embodied as a filter nonwoven or as an open-cell foam, for example, as a polyurethane foam, in which the activated carbon as well as the adhesive are received. Embodiments are conceivable in which, for producing the filter element, first the adhesive is introduced into the open-cell foam of the carrier medium and subsequently the activated carbon is introduced. Possible is also the embodiment of first applying the adhesive onto the activated carbon and then introducing the activated carbon-adhesive mixture into the open-cell foam of the carrier medium.

In an advantageous embodiment, the carrier medium can be designed as a carrier layer and the activated carbon can form an activated carbon layer which immediately adjoins the carrier layer; a carrier layer may adjoin at one side or both sides. The carrier medium is carrier of the activated carbon or at least adjoins the activated carbon layer. The carrier medium is, for example, embodied as a carrier layer or ply that, as needed, takes over a mechanical filtration of particulate contaminants of the gaseous fluid to be purified. In this case, the carrier medium forms, for example, a carrier nonwoven or filter nonwoven at which dirt particles can be separated. The filter nonwoven is comprised of a thermoplastic material that may be filled with glass fibers or unfilled, for example, of polyester, polyamide, polyacrylonitrile, polycarbonate or polypropylene.

In the embodiment of the carrier medium as a carrier layer, the activated carbon forms an activated carbon layer which adjoins immediately the carrier layer and is preferably connected by means of the adhesive to the carrier layer. The carrier layer delimits thus the activated carbon layer at least at one side and is at the same time connected to the activated carbon layer.

Moreover, the activated carbon layer can be delimited at its two side faces by a carrier layer, respectively; an intermediately positioned activated carbon layer and two carrier layers form a media layer. Expediently, the activated carbon layer is also glued to the two carrier layers. A media layer or stack unit is comprised thus of two carrier layers and an intermediately positioned activated carbon layer, wherein, as needed, several stack units can be stacked on each other.

By means of different number of layers or stack units, even great heights with relatively minimal lengths and widths of the filter element can be realized, as needed. The greater height goes hand in hand with longer residence times and an improved effective adsorption and leads to longer service lives of the activated carbon filter.

In a further expedient embodiment, at least two activated carbon layers can thus adjoin each other.

Advantageously, the specified use of the filter element can be in a cathode air filter for a fuel cell system.

The invention concerns according to a further aspect a fuel cell filter system with a fuel cell filter element, wherein the fuel cell filter element is exchangeably arranged in the fuel cell filter system. The significant advantage of such a filter system resides in this context in the safe and stable assembly of the filter element as well as a very economical exchangeability of the filter element during service.

In a further development, the plastic frame of the filter element can even be embodied as a component of a housing or a housing wall of a filter system, whereby savings in regard to material, weight, and costs of the entire filter system are possible.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will expediently consider the features also individually and combine them to other expedient combinations.

FIG. 1 shows in schematic illustration a body of a fuel cell filter element, that comprises activated carbon as an adsorption agent, with two media layers stacked on each other which are comprised each of two carrier layers with intermediately positioned activated carbon layer, according to an embodiment of the invention.

FIG. 2 shows a body of a fuel cell filter element with different carrier layers and activated carbon layers, according to a further embodiment of the invention.

FIG. 3 shows a fuel cell filter element embedded in plastic material in a housing of a filter system, according to an embodiment of the invention.

FIG. 4 shows a fuel cell filter element embedded in plastic material, sealed by a sealing element, in a housing of a filter system, according to a further embodiment of the invention.

FIG. 5 shows a fuel cell filter element, embedded by plastics injection molding, with a connecting flange in a housing of a filter system, according to another embodiment of the invention.

FIG. 6 shows a fuel cell filter element, embedded by plastics injection molding, with a particle filter that is stabilized by webs, according to a further embodiment of the invention.

FIG. 7 shows a fuel cell filter element, embedded by plastics injection molding that is joined about its outer circumference in a housing of a filter system, according to a further embodiment of the invention.

FIG. 8 shows a fuel cell filter element, embedded by plastics injection molding that is joined by an end face in a housing of a filter system, according to another embodiment of the invention.

FIG. 9 shows a fuel cell filter system with a fuel cell filter element, embedded by plastics injection molding that by means of a connecting flange is connected to the housing of the filter system, according to a further embodiment of the invention.

### DESCRIPTION OF PREFERRED EMBODIMENTS

In the Figures, same or same-type components are identified with same reference characters. The Figures show only examples and are not to be understood as limiting.

In FIG. 1, a body 40 of a fuel cell filter element 10 (in the following Figures only referred to as filter element 10) is illustrated in schematic illustration and comprises activated carbon as adsorption agent, with two media layers 20 that are stacked on each other which are each comprised of two carrier media 12 in the form of carrier layers 14 with intermediately positioned activated carbon layer 18, according to an embodiment of the invention. The filter element 10 serves for filtration of a gaseous medium, wherein by means of the filter element 10 a mechanical as well as chemical purification can be carried out. By means of the filter element 10, dirt particles and gaseous chemical substances can be removed from the air that is to be supplied, for example, to a fuel cell.

The filter element 10 comprises at least two media layers 20 that are stacked on each other which are each comprised of two parallel extending carrier layers 14 and an intermediately positioned activated carbon layer 18 or a combination with other media. The carrier layers 14 form each a filter nonwoven which is used for particle separation. The activated carbon layer 18 acts as adsorption agent for adsorption of volatile components which are entrained in the gas flow. The flow direction is realized orthogonally to the plane of the carrier layers 14 or the activated carbon layers 18. Alternatively, the carrier layer 14 can also be embodied as an open-cell foam in which the activated carbon and the adhesive are received.

The filter nonwoven of the carrier layers 14 is comprised, for example, of polyester, polyurethane, polyamide, polyacrylonitrile, polycarbonate, polypropylene filled with glass fibers or also unfilled, ABS, thermoplastic material. The activated carbon in the activated carbon layer 18 is reinforced by means of the adhesive or immobilized so that the individual activated carbon particles are not freely movable within the activated carbon layer but assume a fixed position in the layer. A reactive adhesive, for example, based on polyurethane, or a thermoplastic adhesive, for example, based on polyolefins, is conceivable as adhesive. The adhesive comprises adhesive threads which adhere to the surface of the activated carbon particles and effect thereby the adhesive connection.

The activated carbon layer 18 is also fixed to both carrier layers 14 which is a component of the respective media layer 20 and located at the two side faces of the activated carbon layer 18. At the end faces, i.e., long and wide sides, the activated carbon layer 18 can be provided with a seal which imparts to the activated carbon layer an additional stability and securing action against delamination and displacement.

The individual media layers 20, which are stacked on each other, can be either loosely layered on each other or can also be secured on each other by gluing. Optionally, the filter element 10 can comprise more than two media layers 20.

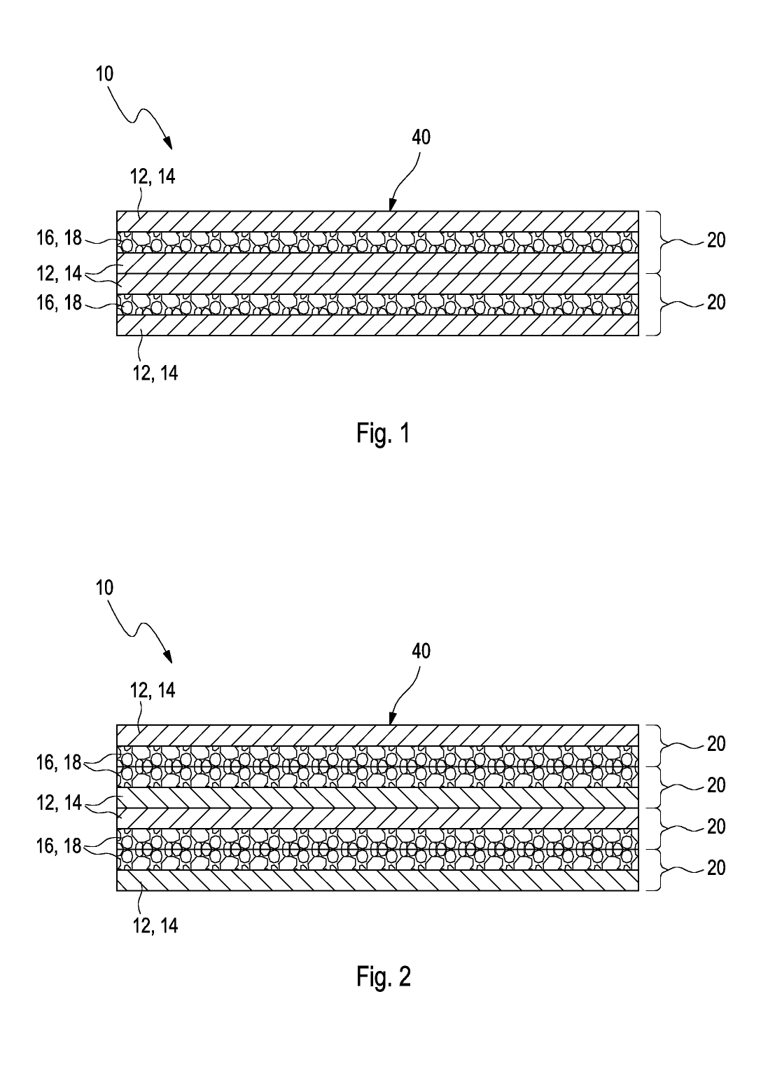

In FIG. 2, a further embodiment is illustrated in which the filter element 10 comprises also several media layers 20 stacked on each other. Each media layer 20 is comprised of a carrier layer 14 and an activated carbon layer 18. An adhesive is introduced into the activated carbon layer 18 in order to immobilize the activated carbon particles. The activated carbon layer 18 is fixed by the adhesive to the corresponding carrier layer 14 with which the activated carbon layer 18 forms the media layer 20.

According to FIG. 2, two media layers 20 are respectively stacked on each other in such a way that the activated carbon layers 18 are facing each other. In this way, a stack unit of two media layers 20 results which is delimited by a top and a bottom carrier layer 14 between which two immediately adjoining activated carbon layers 18 are arranged. In the embodiment according to FIG. 2, two such stack units with two media layers 20 each are stacked on each other. In principle, more than two stack units can be stacked on each other, however.

In the embodiment according to FIG. 2, the activated carbon layers 18 can also be provided with a seal at their end faces, i.e., the wide sides and the long sides.

Activated carbon layers 18 which are immediately resting on each other are advantageously not glued together but instead the adhesive connection is realized only by means of the immediately adjoining carrier layer 14.

Carrier layers 14 of the stack units that are directly resting on each other can be optionally connected to each other, for example, by gluing,

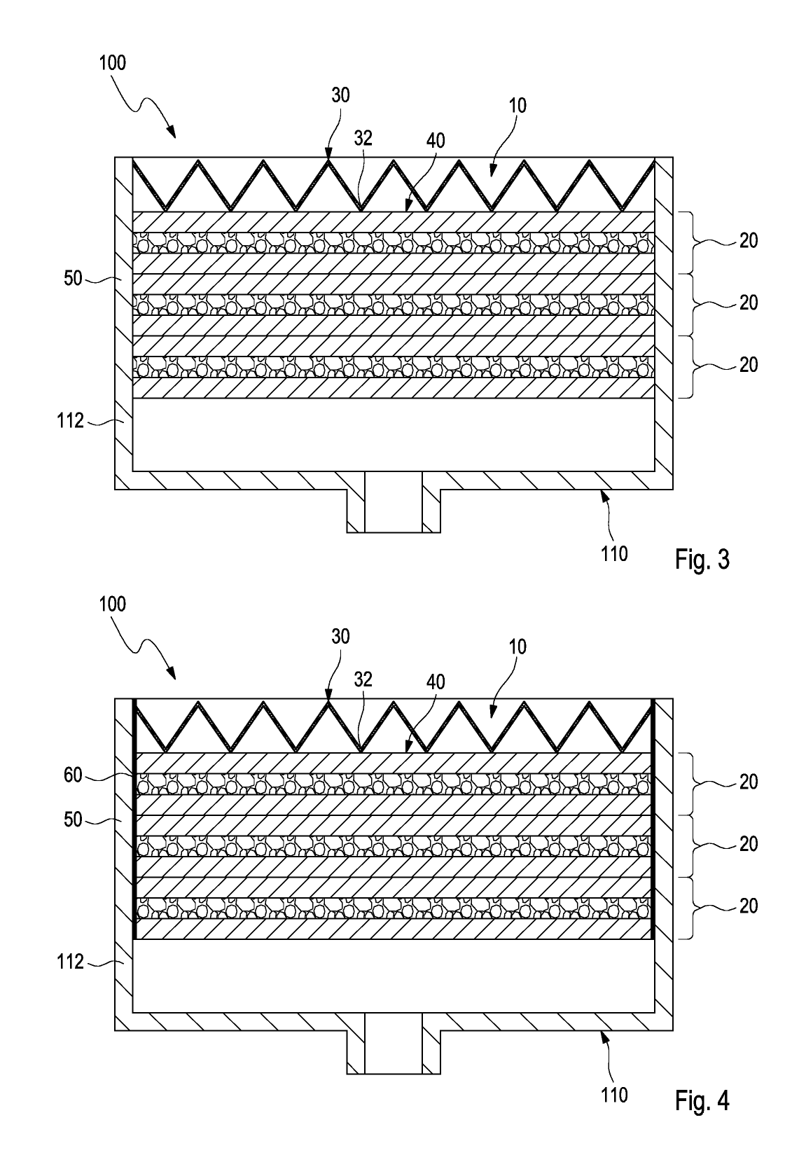

FIG. 3 shows a filter element 10 embedded in plastic material in a housing 110 of a fuel cell filter system 100 (referred to only as filter system 100 in the following Figures), according to an embodiment of the invention. The filter element 10, comprised of a body 40 with three media layers 20, wherein each media layer 20, for example, as illustrated in FIG. 1, can comprise two carrier layers 14 with an intermediately positioned activated carbon layer 18, and further comprised of a particle filter 30, is embedded in a housing 110 with a plastic frame 50, wherein the housing 110 is usable as a part of the filter system 100. In this context, the media layers 20 with their end faces are embedded by injection molding directly into the housing wall 112. The particle filter 30, which is comprised in particular of a folded filter medium, comprises a comb-like cross section with comb peaks and comb valleys 32. The housing 110 can be produced, for example, by an injection molding method wherein the filter element 10 is fixedly connected in this way directly to the housing 110. Alternatively, a blow molding method can be employed also wherein—in contrast to what is shown in the Figures—the cross section transition to the clean air connector is embodied in a suitable way in a rounded shape.

In FIG. 4, a filter element 10, embedded in plastic material and sealed with a sealing element 60, in a housing 110 of a filter system 100 according to further embodiment of the invention is illustrated. In this context, the arrangement of the filter element 10 is illustrated very similar to FIG. 3 but the media layers 20 of the body 40 with the particle filter 30 are closed off at their end faces with a sealing element 60, for example, a lateral band. In this way, the media layers 20 with the particle filter 30 are arranged as a package that, when inserted into a tool during the manufacture, can be handled more easily and protects the tool from possible soiling. Also, the sealing action between the media layers 20 with the particle filter 30 relative to the plastic frame 50 of the housing wall 112 of the housing 110 can be embodied reliably.

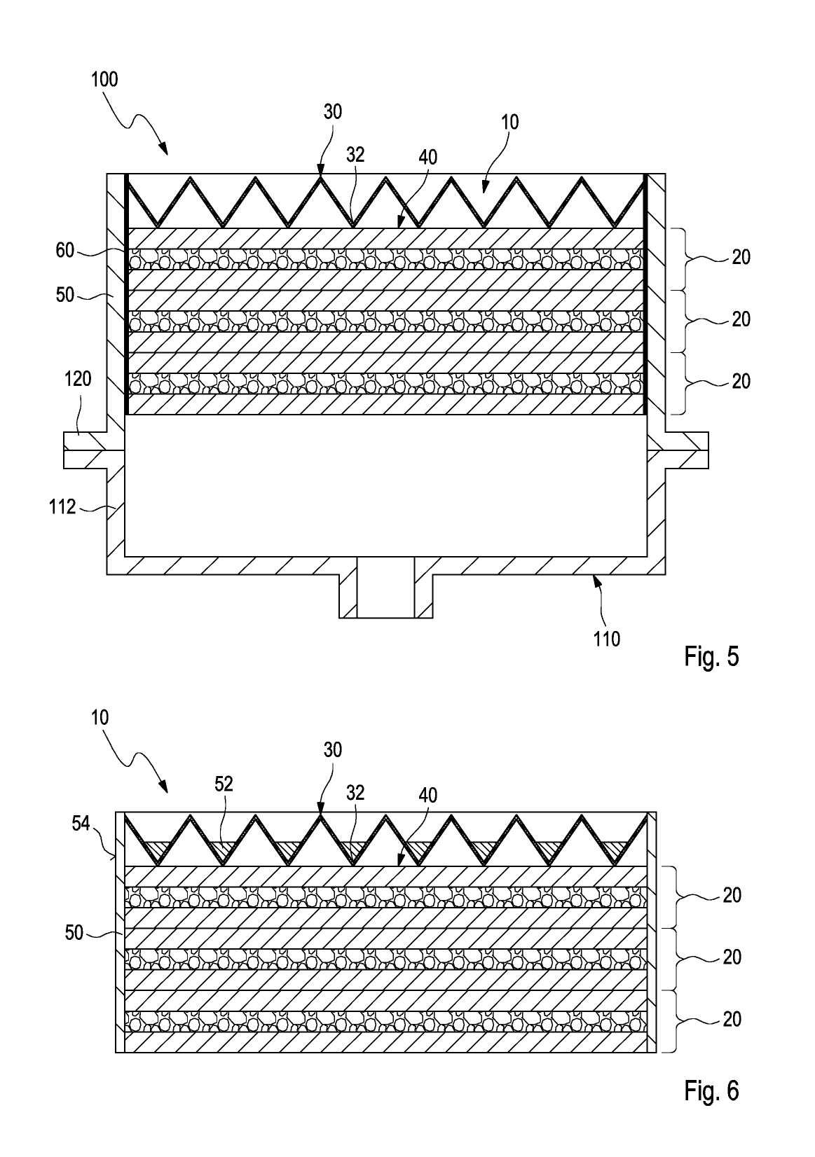

FIG. 5 shows a filter element 10, embedded by plastics injection molding, with a connecting flange 120 in a housing 110 of a filter system 100, according to another embodiment of the invention. In this embodiment, the body 40 is also directly embedded by injection molding in the housing wall 112 of a housing 110 of a filter system 100 but the plastic frame 50 represents only a portion of the complete housing of the filter system 100 that can be joined with a connecting flange 120 to a complete housing. In this way, the filter element 10 can be easily exchanged during service.

In FIG. 6, a filter element 10, embedded by plastics injection molding, with a particle filter 30 that is stabilized by webs 52 according to a further embodiment of the invention is illustrated. The body 40 of the filter element 10 that comprises three media layers 20 with a particle filter 30 is embedded in a plastic frame 50 by injection molding. Webs 52 are provided in the comb valleys 32 of the particle filter 30 and may comprise, for example, plastic webs which fix the comb valleys 32 and are also embedded by injection molding in the plastic frame 50. In this way, the entire filter element 10 is mechanically well fixed even in case of a mechanical load by higher fluid flow rates in operation of the filter system 100. The plastic frame 50 comprises at its outer surface a connecting surface 54 for connection with a housing 110 of a filter system 100. The connecting surface 54 can be embodied, for example, as a welding surface.

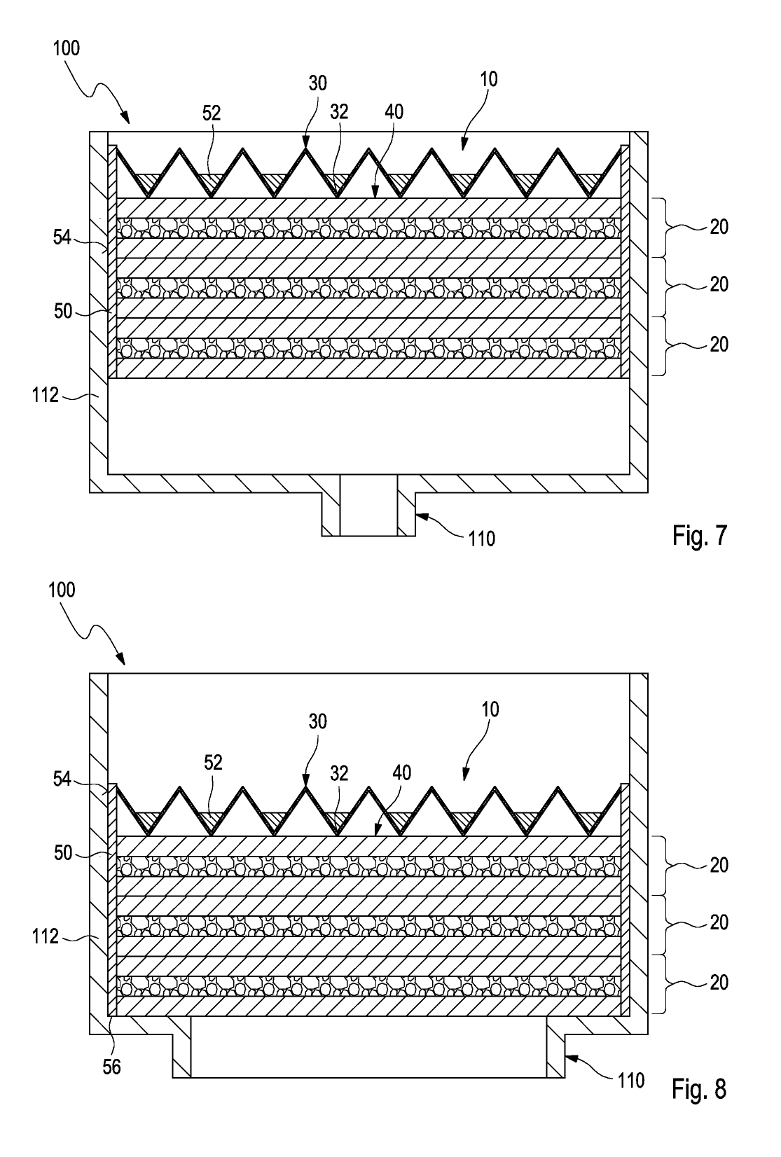

FIG. 7 shows a filter element 10, embedded by plastics injection molding that is joined by its outer circumference in a housing 110 of a filter system 100, according to a further embodiment of the invention. In this context, the filter element 10, for example, as illustrated in FIG. 6, is welded by the outer circumference of the plastic frame 50, which can be embodied as a connecting surface 54 in the form of a welding and/or gluing surface, into a housing 110 of the filter system 100 and is thus connected fixedly with the housing 110. As a joining technique, conventional plastics welding methods can be used. Alternatively, the filter element 10 can also be glued in.

In FIG. 8, a filter element 10, embedded by plastics injection molding that is joined by an end face 56 in a housing 110 of a filter system 100 in accordance with another embodiment of the invention is illustrated. In this embodiment, the plastic frame 50 of the filter element 10 is connected by an end face 56 with the housing 110. Here, conventional plastics welding methods can be used also.

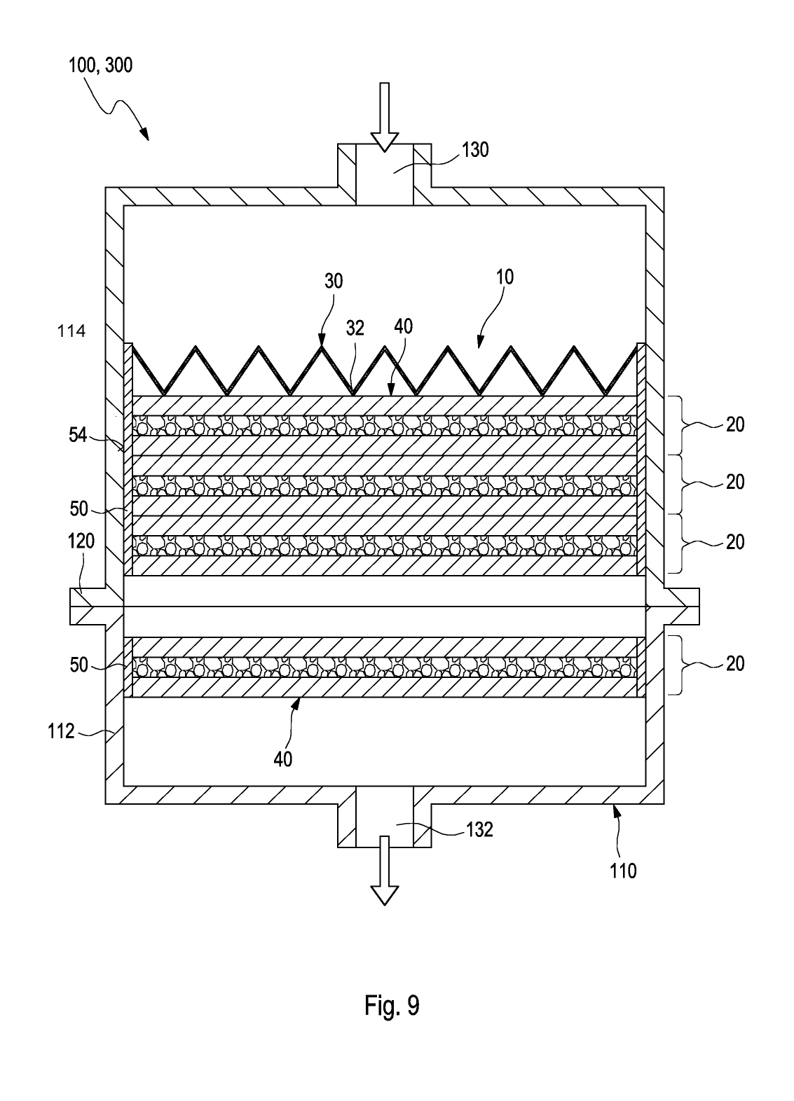

FIG. 9 shows a filter system 100 with a filter element 10, embedded by plastics injection molding that is connected with a connecting flange 120 to a housing 110 of the filter system 100, according to a further embodiment of the invention. The housing 110 of the filter system 100 is comprised here of two housing wall parts 112 and 114. A filter element 10 is fixedly joined in the top housing wall part 114, as disclosed in FIG. 7. Alternatively, the plastic frame 50 of the filter element 10 can be a component of the housing 110 or a housing wall 114. A further single layer body 40 with a media layer 20 can be joined also additionally in the bottom housing part 112. Both housing wall parts are connected by a connecting flange 120 so that the filter element 10 can be easily exchanged during service, respectively. The top housing wall part 114 as well as the bottom housing wall part 112 could be exchanged separately. The filter system 100 comprises an inlet 130 and an outlet 132 whereby the flow direction is predetermined. The filter system 100 can be used in this configuration, for example, as a cathode air filter 300 of a fuel cell system.

What is claimed is:

1. A fuel cell filter element comprising:
a carrier medium and an adsorption agent, wherein the carrier medium and the adsorption agent are joined to a single-layer or multi-layer body:
a plastic frame;
wherein the single-layer or multi-layer body is directly fixedly connected to the plastic frame by injection molding or blow molding;
wherein the plastic frame comprises a connecting surface configured to connect to a housing wall of a filter system into which the fuel cell filter element is insertable.

2. The fuel cell filter element according to claim 1, wherein the plastic frame is embodied as a component of the housing wall of the filter system.

3. The fuel cell filter element according to claim 1, wherein the plastic frame comprises a connecting flange.

4. The fuel cell filter element according to claim 1, wherein the plastic frame comprises a welding and/or gluing surface arranged at an outer circumference of the plastic frame.

5. The fuel cell filter element according to claim 1, wherein the plastic frame comprises a welding and/or gluing surface arranged at one or two end faces of the plastic frame.

6. The fuel cell filter element according to claim 1, further comprising a particle filter arranged at a specified inflow side of the single-layer or multi-layer body.

7. The fuel cell filter element according to claim 6, wherein the particle filter comprises a folded filter medium.

8. The fuel cell filter element according to claim 7, wherein the particle filter is stabilized by one or several webs or a support grid.

9. The fuel cell filter element according to claim 1, wherein one or several lateral edges of the single-layer or multi-layer body are sealed with a sealing element prior to connecting the single-layer or multi-layer body by injection molding to the plastic frame.

10. The fuel cell filter element according to claim 1, wherein particles of the adsorption agent are immobilized by addition of an adhesive.

11. The fuel cell filter element according to claim 10, wherein the adhesive is a reactive adhesive or a thermoplastic adhesive.

12. The fuel cell filter element according to claim 10, wherein the carrier medium is embodied as an open-cell foam in which the adsorption agent in the form of activated carbon and the adhesive are received.

13. The fuel cell filter element according to claim 1, wherein the carrier medium is embodied as a filter nonwoven.

14. The fuel cell filter element according to claim 1, wherein the carrier medium is embodied as a carrier layer and wherein the adsorption agent is activated carbon and forms an activated carbon layer which immediately adjoins the carrier layer.

15. The fuel cell filter element according to claim 14, wherein the activated carbon layer comprises opposite side faces and adjoins two of the carrier layers arranged at the opposite side faces.

16. The fuel cell filter element according to claim 1, wherein the adsorption agent is activated carbon and forms activated carbon layers, wherein at least two of the activated carbon layers adjoin each other.

17. The fuel cell filter element according to claim 1, arranged in a cathode air filter for a fuel cell system.

18. A fuel cell filter system comprising an exchangeable fuel cell filter element, wherein the fuel cell filter element comprises a carrier medium and an adsorption agent, wherein the carrier medium and the adsorption agent are joined to a single-layer or multi-layer body, wherein the fuel cell filter element further comprises a plastic frame, wherein the single-layer or multi-layer body is directly fixedly connected to the plastic frame by injection molding or blow molding, and wherein the plastic frame comprises a connecting surface configured to connect to a housing wall of the fuel cell filter system.

19. The fuel cell filter system according to claim 18, wherein the plastic frame is embodied as a component of the housing wall.

20. The fuel cell filter system according to claim 18, wherein the plastic frame is embodied as a component of a housing of the fuel cell filter system.
